(19) United States
(12) Patent Application Publication
(10) Pub. No.: US 2009/0110271 A1
(43) Pub. Date: Apr. 30, 2009

(54) COLOR RECOGNITION DEVICE AND METHOD THEREOF

(75) Inventors: Yu-Chieh Chen, Hsinchu City (TW); Tai-Shan Liao, Hsinchu City (TW); Chi-Hung Huang, Hsinchu City (TW); Chien-Jen Chen, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: NATIONAL APPLIED RESEARCH LABORATORIES, Taipei (TW)

(21) Appl. No.: 11/965,129

(22) Filed: Dec. 27, 2007

(30) Foreign Application Priority Data
Oct. 31, 2007 (TW) 96141105

(51) Int. Cl. G06K 9/00

(52) U.S. Cl. 382/165

(57) ABSTRACT

A color recognition device is provided. The color recognition device includes a color image sensor, an image processing system, and a projection device. The color image sensor senses a color image having an image area with a specific color, and generates a first electrical signal corresponding to the color image. The image processing system receives the first electrical signal, modifies the color image, and generates a second electrical signal. The projection device receives the second electrical signal, and projects a modified image corresponding to the second electrical signal.

### FIELD OF THE INVENTION

The present invention relates to a color recognition device, and more particularly to a color recognition device for the color blind people.

### BACKGROUND OF THE INVENTION

According to the statistical data, about 10% of the total global population are slightly or seriously color blind people. Most of them are red-green color blind. The biggest difficulty for the color blind is their inability to drive a car, because the color blind can not distinguish the red, yellow, and green traffic signals.

There are three kinds of color light sensitive cone cells in human retina, so the human eyes can distinguish colors. These three kinds of cone cells can absorb the lights with different wavelength range, i.e. “blue”, “green” and “red” basic color lights, respectively. When some kinds of cone cells are damaged or grow improperly, the color blindness may occur.

There are color blindness rectification glasses available in the market. The principle of these glasses is to form the optical coating on these glasses to generate the wavelength cut-off effect, i.e. the filtration of some specific color light. For the example of the red-green blindness, these color blindness rectification glasses can transmit the long wavelength light (red light) and reflect the short wavelength light (blue light). That is to say, almost all red light will pass through the color blindness rectification glasses, while most blue light will be reflected by the color blindness rectification glasses, and only a small amount of blue light can pass through the color blindness rectification glasses. Since the red-green blind people have the low sensitivity to red light and high sensitivity to blue light, therefore the red light with relatively high intensity after passing the color blindness rectification glasses can reach the balancing of the three basic colors sensed by the user so that he or she may distinguish the colors.

However such color blindness rectification glasses have several drawbacks. First, since a large portion of light has been filtered out (for instance, most blue light and part of green light), thus the total light intensity is greatly reduced. Moreover, the red-green blind people have low sensitivity to red light, even though the intensity of the red light is high. Actually, the light after passing through the color blindness rectification glasses and being sensed by the red-green blind people is several-times weaker than that sensed by the normal people without the color blindness rectification glasses. Consequently, the images may not be clearly seen in a cloudy day due to the weakly sensed light for a color blind person wearing the color blindness rectification glasses. It is dangerous when driving a car in this situation. Besides, the color blindness rectification glasses only work for slight color blind people and become invalid for serious color blind people. For example, it is hard for the serious red-green color blind people to sense the red light no matter how strong the adjusted red light intensity is, because the color blindness rectification glasses just filter out the blue light to achieve a color balancing only.

In order to solve the above-mentioned problems, the new concepts and resolution method are proposed in the present invention, which is able to help the serious color blind people to easily distinguish the colors and the traffic signals. The present invention is described below.

### SUMMARY OF THE INVENTION

In accordance with one aspect of the present invention, a color recognition device for color blind people is provided. The color recognition device of the present invention is easy to be carried or worn and able to help color blind people to distinguish the colors, specially the colors of the traffic signals to avoid the possible danger.

In accordance with another aspect of the present invention, a color recognition device is provided. The color recognition device includes a color image sensor, an image processing system, and a projection device. The color image sensor senses a color image having an image area with a specific color, and generates a first electrical signal corresponding to the color image. The image processing system receives the first electrical signal, modifies the color image, and generates a second electrical signal. The projection device receives the second electrical signal, and projects a modified image corresponding to the second electrical signal.

Preferably, the color image sensor is worn on a head of a user.

Preferably, the color recognition is worn on a head of a user.

Preferably, the color image sensor includes one of a complementary metal oxide semiconductor and a charge coupled device.

Preferably, the image processing system includes a field programmable gate array.

Preferably, the modified image has a modified image area corresponding to the image area with the specific color, and the modified image area is displayed by flashing.

Preferably, the modified image has a modified image area corresponding to the image area with the specific color, and a light intensity of the modified image area is increased.

Preferably, the projection device includes a projection component of a liquid crystal on silicon.

Preferably, the projection device includes a projection component of a liquid crystal display.

Preferably, the projection device includes a projection component having a plurality of mirrors made by a method of micro-electro-mechanical system.

Preferably, the modified image is projected on an image display device containing a semi-transparent and semi-reflective lens.

Preferably, the modified image is projected on an image display device containing a semi-transparent and semi-reflective beam splitter.

In accordance with a further aspect of the present invention, a method of color recognition is provided. The method includes steps of sensing a color image having an image area with a specific color to generate a first electronic signal corresponding to the color image, modifying the first electronic signal to generate a second electronic signal for creating a modified image, and projecting the modified image.

Preferably, the modified image has a modified image area corresponding to the image area with the specific color, and the second electronic signal keeps the modified image area flashing.

Preferably, the modified image has a modified image area corresponding to the image area with the specific color, and the second electronic signal increases a light intensity of the modified image area.

Preferably, the method further includes a step of transmitting the second electronic signal to a projection device for projecting the modified image.

Preferably, the projection device includes a projection component being one selected from a group consisting of a liquid crystal on silicon, a liquid crystal display, and a component having a plurality of mirrors made by a method of micro-electro-mechanical system.

Preferably, the modified image is projected on an image display device for a user to view the color image and the modified image simultaneously.

Preferably, the modified image is projected on an image display device for a user to view only the modified image.

In accordance with further another aspect of the present invention, a color highlighting device including a color image sensor, an image processing system, and a projecting device is provided. The color image sensor senses a color image having an image area with a specific color. The image processing system modifies the color image and generates a modified image, which has a highlighted image area corresponding to the image area with the specific color. The projecting device projects the modified image.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is an exploded view of the color recognition device according to the first embodiment of the present invention;

FIG. 2 is a front view of the color recognition device according to the first embodiment of the present invention;

FIG. 3 is a side view of the color recognition device according to the first embodiment of the present invention;

FIG. 4 is a side view of the image display device according to the first embodiment of the present invention; and

FIG. 5 is a top view of the color recognition device according to the second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

### First Embodiment

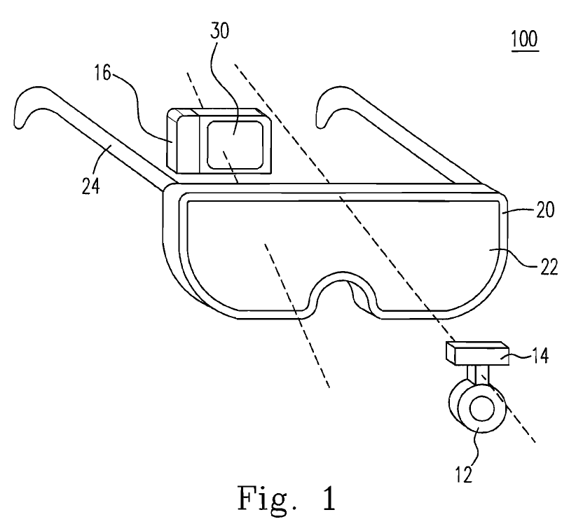

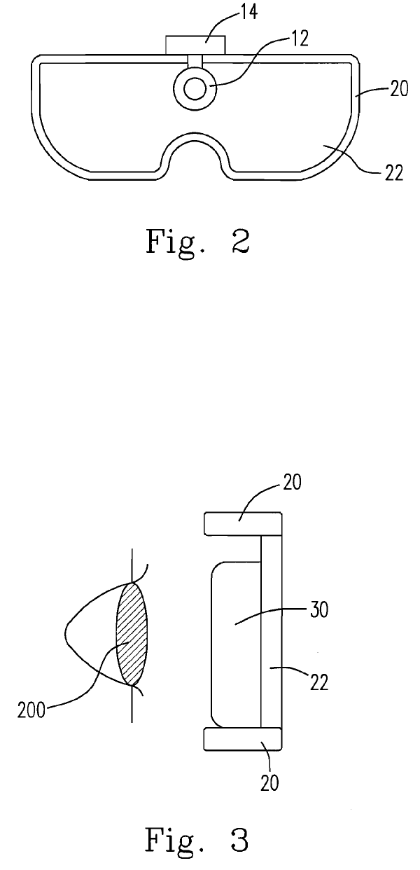

Please refer to FIG. 1, which is an exploded view of the color recognition device according to the first embodiment of the present invention. As shown in FIG. 1, the color recognition device 100 can be worn on the head of the user like normal glasses. The color recognition device 100 includes a frame 20, a lens 22, a supporting element 24, a color image sensor 12, an image processing system 14, a projection device 16, and an image display device 30. Please refer to FIG. 2, which is a front view of the color recognition device according to the first embodiment of the present invention. As shown in FIG. 2, the color image sensor 12 and the image processing system 14 are located above the center of the color recognition device 100. The color image sensor 12 is used to sense the image and to generate a first electronic signal, such as an electronic file with a picture format, corresponding to that image. Then the first electronic signal is transmitted to the upper image processing system 14. Of course, the image processing system 14 can be designed as located in another place of the color recognition device 100.

The sensing chip of the color image sensor 12 can be a complementary metal oxide semiconductor (CMOS) or a charge coupled device (CCD) or other types of the chromatic light sensing chips. In this embodiment, a CMOS chip with 1.3 million pixels is utilized in the color image sensor 12. Certainly, the light sensing chip with other appropriate pixel quantity can be chosen according to the actual requirements and the user's need. The content of the first electronic signal generated by the color image sensor 12 can contain the dynamic information of the color, e.g. chromatic coordinates, and the light intensity in each specific time frame for each pixel.

The image processing system 14 modifies the image area(s) with a specific color, for example red color, in the color image coded in the first electronic signal, and then generates the second electronic signal. This modification can be accomplished by using the field programmable gate array (FPGA) to keep the image area with a specific color flashing on its edge or on its whole area, or to increase the light intensity of the image area with a specific color, or to do both simultaneously. Then the image information after the modification is coded into a second electronic signal, such as an electronic file with a picture format.

Please refer to FIG. 1. The projection device 16 and the image display device 30 are designed as located behind the lens 22. The projection device 16 receives the second electronic signal transmitted by the image processing system 14, decodes the image information coded in the second electronic signal, and projects the corresponding image on the image display device 30. The reflective liquid crystal on silicon (LCoS), the transmissive liquid crystal display (LCD), or the chip set containing micro-mirrors made by the method of the micro-electro-mechanical system (MEMS), e.g. a digital light processing (DLP®) chip, can be chosen to attain the projection function for the projection device 16. Meanwhile, since the modification on the image area(s) with a specific color has been completed and coded in the second electronic signal, therefore the image will be displayed in the following ways. The image area with a specific color will be flashing on its edge or on its whole area, or the light intensity of the image area with a specific color will be intensified, or both the above ways proceed simultaneously. Consequently, the user can see the modified image from the image display device 30 to recognize whether there is any area with a specific color in the image.

Please refer to FIG. 3, which is a side view of the color recognition device according to the first embodiment of the present invention. The image display device 30 is disposed on the frame 20, and positioned between the lens 22 and the eye 200. The image light beam corresponding to the second electronic signal is projected to the eye 200 by the image display device 30. Thus the user can see the modified image to recognize whether there is any image area with a specific color in the modified image.

For instance, the red-green color blind people may clearly see the image, but can hardly distinguish the red and green colors. Therefore the red-green color blind people can not recognize whether the red traffic signal is turned on, and possibly may be in danger. If the red-green color blind person wears the color recognition device 100 of the present invention, he or she can tell whether the light with a specific color, e.g. red light, is turned on, by seeing whether the position of the traffic signal is flashing from the image display device 30. Therefore the red-green color blind people can avoid the possible danger by wearing the color recognition devices 100, when driving cars or crossing the street, and this is a great benefit for those people.

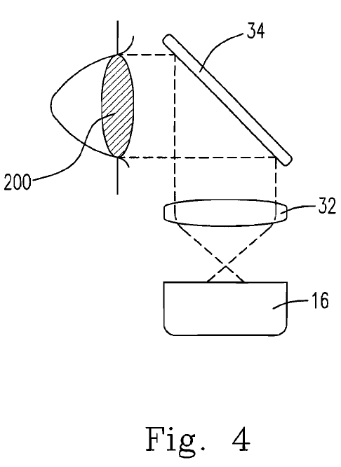

Please refer to FIG. 4, which is a side view of the image display device according to the first embodiment of the present invention, and the detailed inner structure of the image display device 30 is illustrated therein. As shown in FIG. 4, the adjusting lens 32 and beam splitter 34 are disposed inside the image display device 30, and used to adjust the optical parameters of the focal length, position of image, magnification ratio, etc. so as to allow the image to be clearly displayed to the eye 200. The dash lines shown in FIG. 4 are the proceeding path of the image light beam. In some actual applications, a set of lenses, e.g. four pieces of lenses, may be used. The quantity of lenses can be adjusted according to the requirements. Generally more lenses are needed to reach extra higher image quality with higher fidelity and clarity by accurately compensating the image aberration and chromatic aberration. However more lenses will increase the weight and size of the whole device. Therefore one to five lenses by partially or completely introducing the plastic lenses are some choices.

Please refer to FIGS. 3 and 4 together. The beam splitter 34 in FIG. 4 is a semi-transparent and semi-reflective optical element. Accordingly, the real image outside the lens 22 can directly pass through lens 22 and then the beam splitter 34 in the image display device 30, and can finally reach the eye 200. Therefore the user can see the real image like wearing the normal glasses. That is to say, the user can see the real image and the projected image at the same time. In addition, the beam splitter can be designed as a reflector without the transmission function, and then the user can only see the projected image. In this embodiment, the projection device 16 and the image display device 30 are designed as located in front of a single eye, so the other eye can directly see the real image through the lens 22 without any image projected into this eye. Furthermore, two sets of projection devices 16 and image display devices 30 can be designed as located in front of two eyes, respectively.

### Second Embodiment

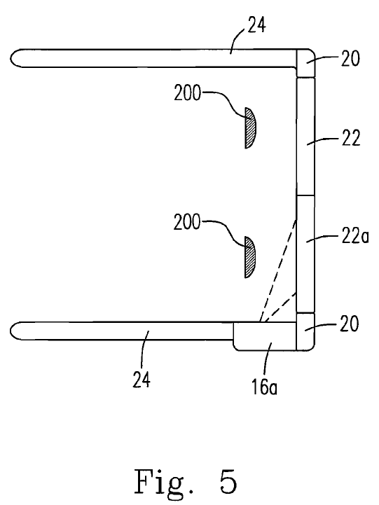

Please refer to FIGS. 1, 3 and 5, where FIG. 5 is a top view of the color recognition device according to the second embodiment of the present invention. The major difference between the first embodiment and the second embodiment is described as the followings. The image display device 30 in the first embodiment contains the beam splitter 34, which is not used in the second embodiment. The lens 22 in the first embodiment is replaced by a semi-transparent and semi-reflective (or semi-scattering) lens 22a as an image display device in the second embodiment. As shown in FIG. 5, the projection device 16a is disposed on the supporting element 24, and can project the image to the image display device, i.e. the lens 22a. The user's eye 200 can see the projected image from the lens 22a. Since the lens 22 is semi-transparent and semi-reflective (or semi-scattering), accordingly the user can see the real image outside the lens 22a and the projected image simultaneously. Of course, the lens 22a can be designed as a reflector or a scattering element, and then the eye 200 behind the lens 22a can only see the projected image and can not see the real image outside the lens 22a.

Since both the color image sensor 12 and the image processing system 14 are adopted in both this embodiment and the first embodiment, the user can still see the modified image to recognize whether there is any area with a specific color in the modified image.

From the above description, a color recognition device and a color recognition method for the color blind people are provided in the present invention. The color image sensor can catch the instant color image and generate the electronic signal. The image processing system can modify the image area(s) with a specific color in the color image to allow the area(s) to be displayed by the ways of flashing, etc. The projection device can project the instant image after the modification on the image display device. The user can see the modified image from the image display device and tell whether there is any area with a specific color in the color image, based on whether there is any area flashing. The present invention provides a great advantage for the color blind people to distinguish the traffic signals and to avoid the possible danger. Moreover, it is easy to carry and convenient to use the color recognition device of the present invention for the color blind people.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A color recognition device comprising:
a color image sensor sensing a color image having an image area with a specific color, and generating a first electrical signal corresponding to the color image;
an image processing system receiving the first electrical signal, modifying the color image, and generating a second electrical signal; and
a projection device receiving the second electrical signal, and projecting a modified image corresponding to the second electrical signal.

2. A color recognition device as claimed in claim 1, wherein the color image sensor is worn on a head of a user.

3. A color recognition device as claimed in claim 1, being worn on a head of a user.

4. A color recognition device as claimed in claim 1, wherein the color image sensor comprises one of a complementary metal oxide semiconductor and a charge coupled device.

5. A color recognition device as claimed in claim 1, wherein the image processing system comprises a field programmable gate array.

6. A color recognition device as claimed in claim 1, wherein the modified image has a modified image area corresponding to the image area with the specific color, and the modified image area is displayed by flashing.

7. A color recognition device as claimed in claim 1, wherein the modified image has a modified image area corresponding to the image area with the specific color, and a light intensity of the modified image area is increased.

8. A color recognition device as claimed in claim 1, wherein the projection device comprises a projection component of a liquid crystal on silicon.

9. A color recognition device as claimed in claim 1, wherein the projection device comprises a projection component of a liquid crystal display.

10. A composite dressing as claimed in claim 1, wherein the projection device comprises a projection component having a plurality of mirrors made by a method of micro-electro-mechanical system.

11. A color recognition device as claimed in claim 1, wherein the modified image is projected on an image display device comprising a semi-transparent and semi-reflective lens.

12. A color recognition device as claimed in claim 1, wherein the modified image is projected on an image display device comprising a semi-transparent and semi-reflective beam splitter.

13. A method of color recognition comprising steps of:
sensing a color image having an image area with a specific color to generate a first electronic signal corresponding to the color image;
modifying the first electronic signal to generate a second electronic signal for creating a modified image; and
projecting the modified image.

14. A method as claimed in claim 13, wherein the modified image has a modified image area corresponding to the image area with the specific color, and the second electronic signal keeps the modified image area flashing.

15. A method as claimed in claim 13, wherein the modified image has a modified image area corresponding to the image area with the specific color, and the second electronic signal increases a light intensity of the modified image area.

16. A method as claimed in claim 13 further comprising a step of transmitting the second electronic signal to a projection device for projecting the modified image.

17. A method as claimed in claim 16, wherein the projection device comprises a projection component being one selected from a group consisting of a liquid crystal on silicon, a liquid crystal display, and a component having a plurality of mirrors made by a method of micro-electro-mechanical system.

18. A method as claimed in claim 13, wherein the modified image is projected on an image display device for a user to view the color image and the modified image simultaneously.

19. A method as claimed in claim 13, wherein the modified image is projected on an image display device for a user to view only the modified image.

20. A color highlighting device, comprising:
a color image sensor sensing a color image having an image area with a specific color;
an image processing system modifying the color image and generating a modified image, wherein the modified image has a highlighted image area corresponding to the image area with the specific color; and
a projecting device projecting the modified image.
